(19) United States
(12) Patent Application Publication
(10) Pub. No.: US 2016/0043555 A1
(43) Pub. Date: Feb. 11, 2016

(54) RECONFIGURABLE POWER APPARATUS

(71) Applicant: EMPOWER ENERGY PTY LTD, Sydney, NSW (AU)

(72) Inventor: Steven Robert Keep Howell, Terrey Hills (AU)

(21) Appl. No.: 14/780,420

(22) PCT Filed: Mar. 4, 2014
(86) PCT No.: PCT/AU2014/000200

§ 371 Date: Sep. 25, 2015

(30) Foreign Application Priority Data
Mar. 26, 2013 (AU) 2013201985

(51) Int. Cl. H02J 3/38; H02J 7/00; H02J 9/06

(52) U.S. Cl. CPC H02J 3/382; H02J 9/061; H02J 7/0068; H02J 7/007; H02J 3/383; H02J 3/386

(57) ABSTRACT

A power apparatus (100) comprises one or more backplanes (101) and removably engageable power modules (302). Each backplane (101) comprises a plurality of slots (102) and each slot (102) is adapted to engage with a corresponding removably engageable power module (302). Each backplane (101) further comprises a bus (104) coupled between each of the slots (102) and at least two said power modules (302) removably engageable with corresponding ones of the slots (102). The power modules (302), which are engaged with the corresponding slots (102), communicate and distribute power with one another via the bus (104).

### TECHNICAL FIELD

The present invention relates generally to a power apparatus and, in particular, to a reconfigurable power apparatus.

### BACKGROUND

Electrical power apparatus such as Uninterruptible Power Supply (UPS), backup generator, battery banks and the like may be used to produce electrical power for an electrical load (e.g., a toaster, a coffee machine, a computer, a supermarket, a data centre) for various reasons, including protection against power loss, regulation of the electrical power supply, and control of electricity costs. One implementation of a power apparatus includes batteries for providing the electrical power, a charger for charging the batteries, and a power converter for converting the battery's DC voltage to an AC voltage for supply to a load.

With growing environmental concerns and increasing grid supply costs, alternative electrical power sources (e.g., solar panels, wind turbines, etc) are being used to reduce the environmental impacts and costs. These alternative power supplies often produce electrical power with different parameters (voltage, frequency) to that of the mains electrical power supply. The corollary of this is that a power apparatus will require a variety of chargers, inverters and battery configurations to appropriately mate the source to the load.

Also, modern appliances operate over a variety of voltages and sometimes frequencies (e.g., telecommunication application operating at 48V DC, or a datacentre at 400 VDC, or any device configured for 110V AC 60 Hz, 240V AC 50 Hz, 220V 3-phase 400 Hz, etc). The varying electrical power supply requirements of the electrical loads means that the power apparatus must use different converters for different electrical loads. Often the converter includes a transformer, which is generally heavy and expensive to manufacture, for changing an AC voltage.

Electrical loads often exhibit electrical load characteristics which are typically better suited to a particular battery. Marine batteries for example are typically constructed for retaining charge for long periods (idle time), whilst being able to rapidly discharge for starter motor operation.

Currently, a user must know what is required for a power apparatus in order to accommodate specific supply requirements. If supply or load circumstances change, it is more than likely that the user must purchase a new power apparatus to accommodate the change.

An alternative solution to the problem is to keep a variety of batteries and electrical components to be able to accommodate changes. However, this alternative solution is costly as a large number of electrical components needs to be purchased and stored.

Another problem also exists when a high-power power apparatus is required. A high-power power apparatus is typically fully assembled before being transported as on-site assembly is costly due to labour and safety requirements. However, a high-power power apparatus is heavy due to the required number of batteries. Thus, a high power rating and the weight of the high-power power apparatus translate to higher transport costs.

### SUMMARY

It is an object of the present invention to substantially overcome, or at least ameliorate, one or more disadvantages of existing arrangements.

Disclosed are arrangements which seek to address the above problems by providing a reconfigurable power apparatus having slots for receiving a variety of removably engageable modules.

According to an aspect of the present disclosure, there is provided a power apparatus comprising: at least one backplane comprising: a plurality of slots each adapted to engage with a corresponding removably engageable power module; and a bus coupled between each of the slots; and at least two said power modules removably engageable with corresponding ones of the slots, the power modules communicating and distributing power with one another via the bus.

According to another aspect of the present disclosure, there is provided a system for managing power distribution, the system comprising: one or more power apparatus, the one or more power apparatus are the power apparatus of any one of claims 1 to 14; and one or more servers connected to the one or more power apparatus, the one or more servers configured to manage operations of the one or more power apparatus.

According to another aspect of the present disclosure, there is provided a method for configuring a reconfigurable power apparatus, the method comprising: determining a master module from a plurality of power modules connected to the reconfigurable power apparatus; providing a first electrical power to the plurality of power modules, the first electrical power being configured to power-up a communication system and an identification memory of each of the plurality of power modules, the identification memory comprises characteristics of the power module; sending control signals, by the master module, to the plurality of power modules; in response to the sent control signals, sending the characteristics of each of the plurality of power modules, using the communication system, to the master module; receiving, at the master module, characteristics of each of the plurality of power modules; determining whether the characteristics of the plurality of power modules are able to meet a determined configuration of the reconfigurable power apparatus; if the characteristics of the plurality of power modules are able to meet the determined configuration of the reconfigurable power apparatus, providing a second electrical power to the plurality of power modules to power-up each of the plurality of power modules; and sending control signals, by the master module, to the plurality of power modules to configure operating parameters of each of the plurality of power modules.

### BRIEF DESCRIPTION OF THE DRAWINGS

At least one embodiment of the present invention will now be described with reference to the drawings, in which:

FIG. 1A shows a schematic representation of a reconfigurable power apparatus;

FIG. 1B illustrates a schematic representation of backplanes of the reconfigurable power apparatus of FIG. 1A;

FIG. 1C shows a schematic representation of a power module of the reconfigurable power apparatus of FIG. 1A;

FIG. 1D shows an elevation view of the reconfigurable power apparatus of FIG. 1A with the power module of FIG. 1C connected to the backplanes of FIG. 1B;

FIG. 1E shows an example of an implementation of the backplanes of FIG. 1B;

FIG. 2 is a flowchart showing a method for configuring the reconfigurable power apparatus of FIG. 1A; and

FIG. 3A is a schematic representation of an example of a power input module for docking on the reconfigurable power apparatus of FIG. 1A;

FIG. 3B is a schematic representation of an example of a power output module for docking on the reconfigurable power apparatus of FIG. 1A;

FIG. 3C is a schematic representation of an example of a combination power module for docking on the reconfigurable power apparatus of FIG. 1A;

FIG. 3D is a schematic representation of an example of a power storage module for docking on the reconfigurable power apparatus of FIG. 1A;

FIGS. 4A to 4D show schematically different power distribution configurations of the reconfigurable power apparatus of FIG. 1A;

FIGS. 5A to 5C are schematic representations of examples of the reconfigurable power apparatus of FIG. 1A being used as a backup generator; and

FIG. 6 shows a system for managing the operation of a plurality of the reconfigurable power apparatus of FIG. 1A.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

The present disclosure relates to a reconfigurable power apparatus having removably engageable power modules (e.g., inverters, regulators, batteries, sources, loads, etc.) to allow a user to modify the functionalities of the power apparatus.

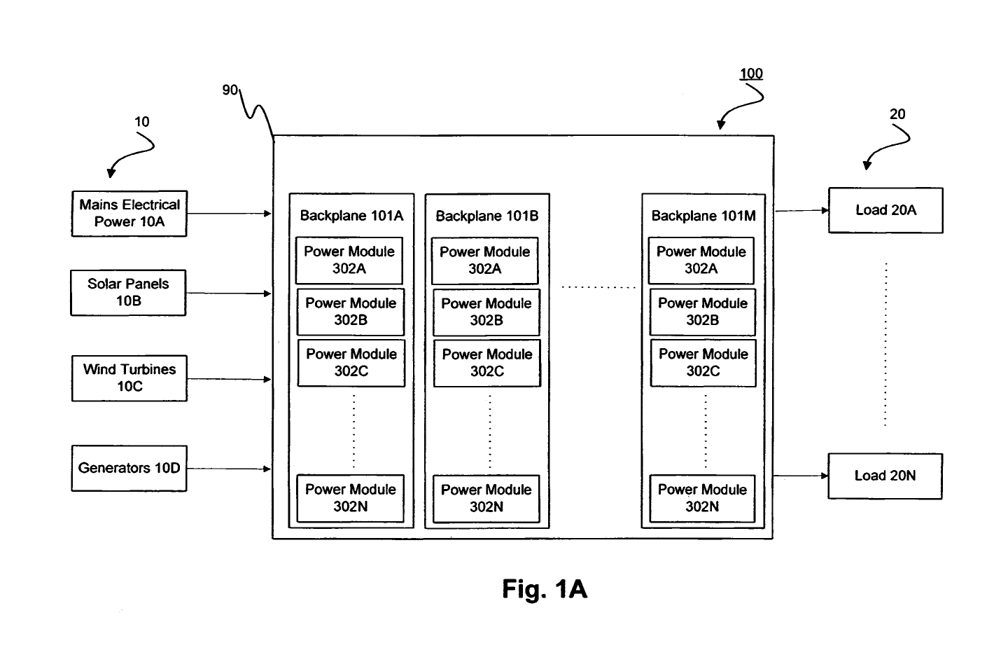

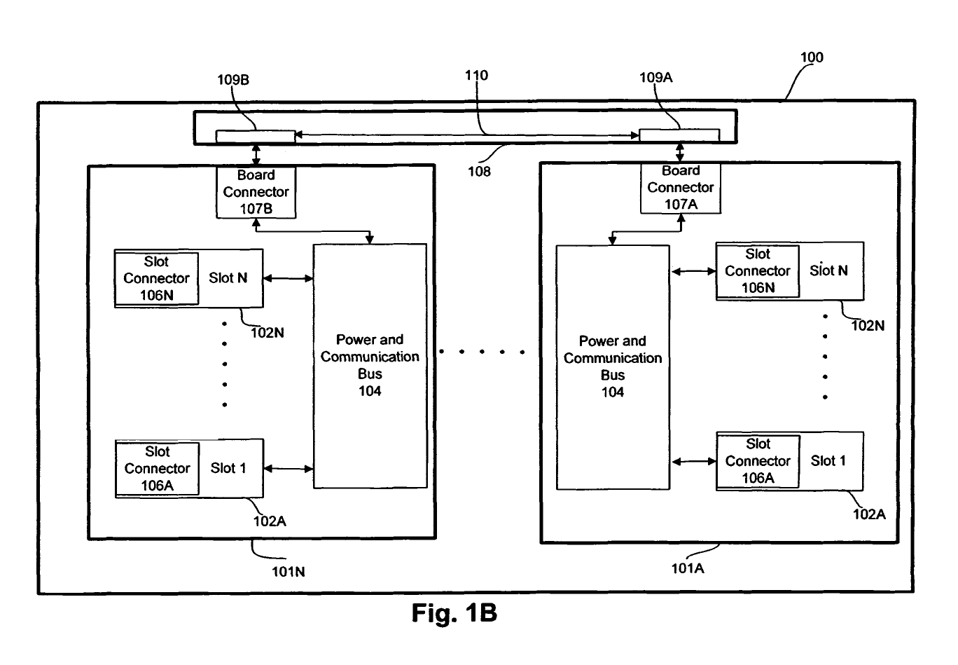

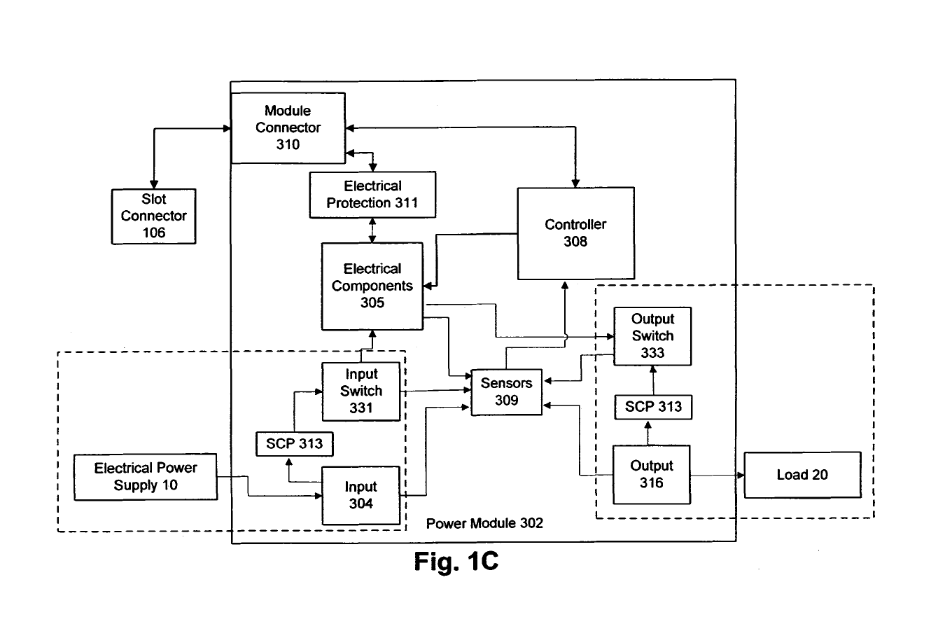

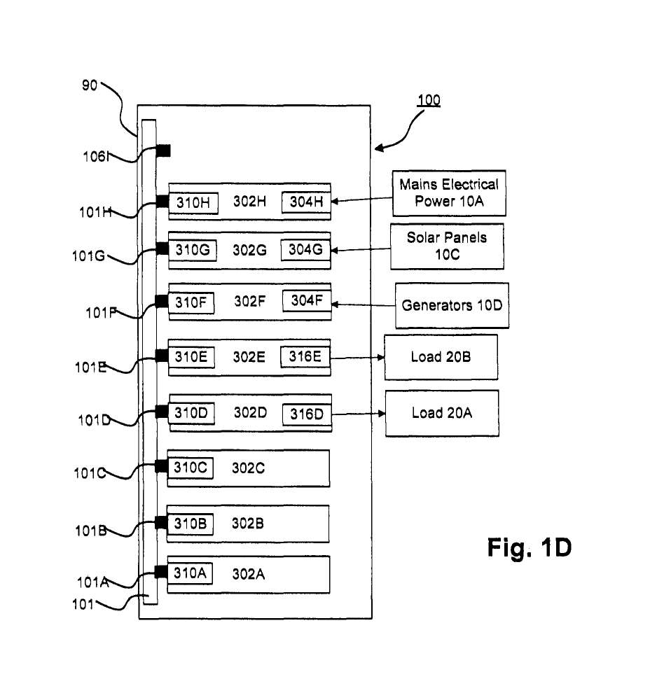

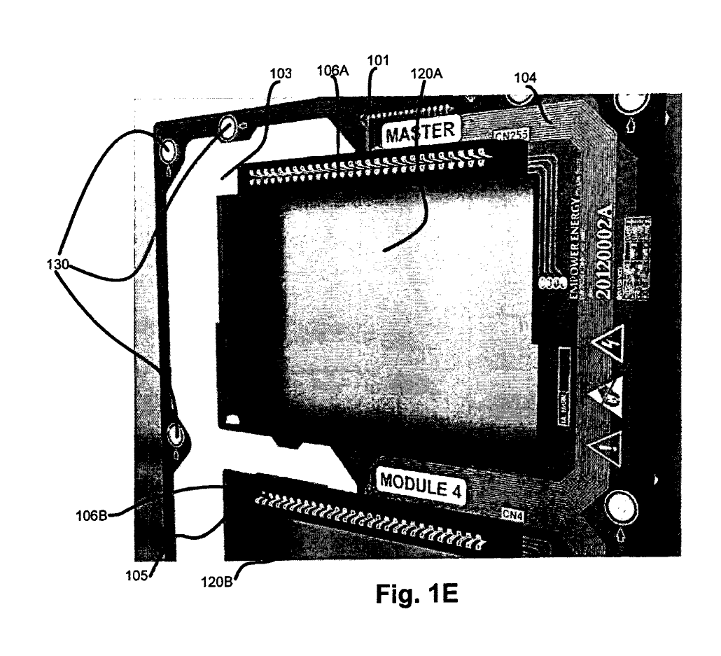

FIG. 1A shows a schematic representation of a reconfigurable power apparatus (PA) 100. The PA 100 comprises a housing 90, backplanes 101A to 101M, collectively referred to as 101, and removably engageable power modules 302A to 302N, collectively referred to as 302. The housing 90 is a metal enclosure for enclosing the backplanes 101 and providing physical protection of the backplanes 101 and the power modules 302. The housing 90 can be made from other materials, for examples, plastic, carbon fibres, etc.

The backplanes 101 are affixed to the housing 90 by using, for example, screws, nuts and bolts, locking glue, retaining clips and other mechanical means. The power modules 302 are then docked on the backplanes 101. Each backplane 101 is capable of accommodating N number of power modules 302. The docking of a power module 302 on a backplane 101 will be discussed further in relation to FIG. 1B.

The PA 100, by using the backplanes 101 and the power modules 302, is capable of receiving electrical power from electrical power supplies 10, processing the received electrical power and outputting the processed electrical power to electrical loads 20. The number of inputs for receiving electrical power from one or more electrical power supplies 10, the number the received electrical power and the number of outputs for outputting power to electrical loads 20 being dependent upon the number (M) of backplanes 101 and the number (M×N) of power modules 302 used in the PA 100.

The backplanes 101 and the power modules 302 can be added to or removed from the PA 100 to provide the reconfigurability aspect of the PA 100. For example, a power module 302 having a converter can be added to an existing configuration of the PA 100 if additional conversion functionality or a larger converter is needed. In another example, one or more backplanes 101 may be added to expand the functionalities of the PA 100. Therefore, a user may readily adapt the PA 100 to suit the need of the user.

In a preferred implementation, the PA 100 is able to use up to 16 (M=16) backplanes 101 whilst the number of power modules that can be docked on each backplane 101 is 9 (N=9). Other numbers (i.e., M and N) of backplanes 101 and power modules 302 may be selected.

Examples of the electrical power supply 10 are mains electrical power supplies 10A, solar panels 10B, wind turbines 10C and generators 10D.

The electrical load 20 is an electrical appliance such as, inter alia, a refrigerator, an oven, an air conditioner, a coffee machine, a toaster, a computer, a supermarket, a data centre or any other device that requires electricity for operation.

FIG. 1B shows a schematic representation of the backplanes 101. Each backplane 101 includes a number of slots 102A to 102N, a Power Transmission and Communication Bus (“Bus”) 104 and a board connector 107. Each backplane 101 is formed of a printed circuit board (PCB) and associated circuitry.

The board connector 107 is configured to engage with another board connector 107, via the use of a PCB 108, so that a plurality of backplanes 101 can be combined. Examples of the board connector 107 are, inter alia, Edge and DIN connectors. On the backplane 101, the board connector 107 is directly connected to the Bus 104 so that connected backplanes 101 may communicate with each other.

The PCB 108 includes complementary board connectors 109 to engage the board connectors 107, and associated circuitry 110 for connecting board connectors 109. The combination of the board connectors 109 and the associated circuitry 110 efficiently connects a plurality of backplanes 101 together when the board connectors 107 are engaged with the board connectors 109. The use of the PCB 108 for connecting backplanes 101 is referred to as modular direct connection. The modular direct connection minimises electrical loss and reduces risk of mechanical failure that may exist when electrical cables are used.

Each slot, collectively referred to as 102, has a slot connector, collectively referred to as 106, to which a power module 302 can dock. Types of slot connectors 106 that can be used are, inter alia, Board Edge or DIN connectors. Upon docking to a slot connector 106, each power module 302 is secured to the corresponding slot 102 via, inter alia, mechanical locks, tab alignment on tray, screws, etc. The number of slots 102 provided on a backplane 101 can be varied during the manufacturing process of the backplane 101.

For example, backplanes 101 are manufactured having a predetermined number of slots (e.g., 2, 4, 6, and 9). In order to dock five (5) power modules 302 to a PA 100, a backplane 101 having either six or nine slots 102 may be used. Alternatively, two backplanes 101, one having two slots 102 and one having four slots 102, may be used.

The interactions between docked power modules 302 of the PA 100 are governed by a master-slave operating system. In one implementation of the backplane 101, the slot 102N is designated as a master-only slot and a power module 302 docked on the slot 102N cannot be operated as a slave module. The slot 102A is designated as a slave-only slot and a power module 302 docked on the slot 102A cannot operate as a master module. Therefore, in this implementation of the PA 100, a master-capable power module 302 is docked on the slot 102N and a master-incapable power module 302 is docked on the slot 102A to ensure that the PA 100 has at least one master module and one slave module.

The remaining slots 102B to 102M are master/slave slots 102. This means that power modules 302 docked on any of the slots 102B to 102M may operate as a master module if needed and if the power module 302 is master-capable. The reason for this implementation is for redundancy purposes in the event that the master module docked on slot 102N fails.

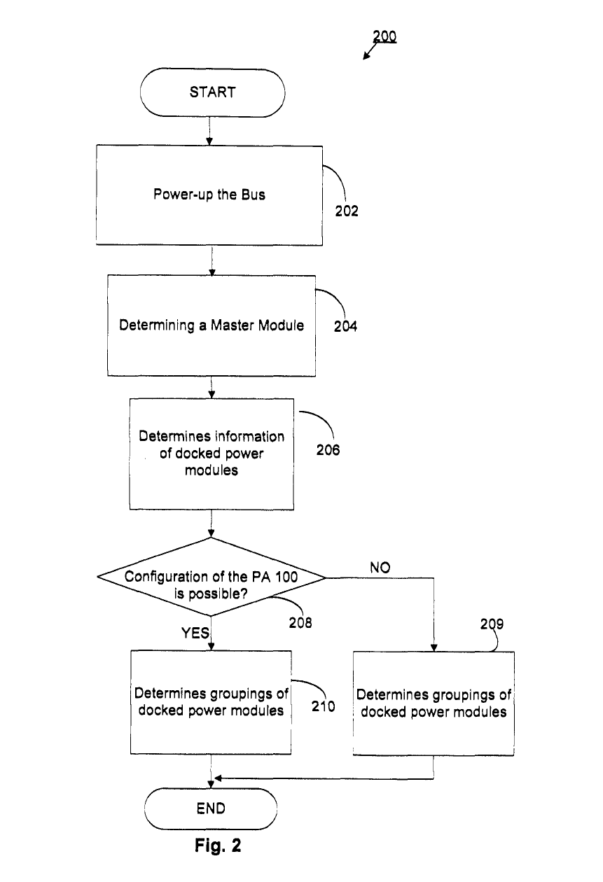

Discussions of the PA 100 are based on this master and slave designations of the slots 102. Other implementations of the slots 102 for master or slave designation are possible, but will not be discussed here. The master-slave operating system is further discussed below in relation to FIG. 2.

Slot 102N has a mechanism for preventing a master-incapable power module 302 from being docked on the slot 102N. The mechanism is discussed in detail in relation to FIG. 1C.

The Bus 104 functionally interconnects the power modules 302 docked to a backplane 101 for communication and power distribution between the power modules 302. Communications between docked power modules 302 are provided in a Serial Peripheral Interface (SPI) Bus. Other possible communication method between docked power modules 302 are UTP Ethernet, SSC (Synchronous Serial Communication), UART (ASYNC), 4 bit bus, QPSI, SPI-3, etc. Communications between connected backplanes 101 are conducted via any one of the following: System Management Bus (SMbus); RS485; Low Voltage Differential Signalling (LVDS); and USB2. Both communication interfaces can be operated simultaneously.

Some of the electrical connections that are provided by the Bus 104 of a backplane 101 are, inter alfa, as follows:
Parallel bus: to provide electrical power from parallel-configured batteries of docked power modules 302;
Serial bus: to provide electrical power from serial-configured batteries of docked power modules 302;
Negative battery voltage terminals: reference voltage for each slot 102;
Ground: the negative terminal of a power storage module in the lowest slot (i.e., slot 1);
Digital Ground;
Digital 5.0V: provides 5.0V DC with reference to the Digital Ground;
Digital 3.3V: provides 3.3V DC with reference to the Digital Ground;
Slot address lines: to provide communication with docked power modules of the backplane 101;
Full duplex serial interface with clocking: provides communications to docked power modules of the backplane 101;
Master/Slave identifier: indicates the Master/Slave status of docked power modules of the backplane 101;
Select lines (Master only): used by a Master module to select a docked power module to communicate with on the backplane 101;
Backplane and Slot identification (Slave only): identifies the address of a Slave module on the backplane 101; and
Fan Interface: to provide control signals (e.g., variable voltage and pulse width modulation (PWM)) to fan(s) of each module bay.

FIG. 1C illustrates an implementation of the power module 302 that can be docked on the backplane 101, via the slot 102. The power module 302 including a controller 308, sensors 309, a module connector 310, an electrical component 305 and an electrical protection 311. Optionally, the power module 302 may include an input 304, an input switch 331, an output 316, an output switch 333 and a signal conditioning and protection (SCP) 313.

The electrical component 305 that can be included in the power module 302 are, inter alia, a power factor corrector, a rectifier, a charger, a boost converter, a buck converter, a voltage regulator, an active rectifier, a battery, etc. The function of the electrical components 305 is to process the electrical power received from the electrical power supply 10, as described above in relation to FIG. 1A.

The electrical component 305 used by a power module 302 is dependent upon the required function of the PA 100. If an inverter is required by the PA 100, then a power module 302 with an inverter as the electrical component 305 is used. If, on the other hand, a rectifier is required by the PA 100, then a power module 302 having a rectifier as the electrical component 305 is used. In one example, the electrical component 305 may be a dummy load in order to discharge excess electricity being generated by the other power modules 302.

The electrical component 305 connects to an electrical protection 311 and, in turn, to the module connector 310 to access the Bus 104. The electrical protection 311 limits the current input/output of the power module 302 to ensure the safe operation of the electrical component 305 and the PA 100. Examples of the electrical protection 311 are, inter alia, current limiter, dynamic current foldback, fuse, etc.

The electrical component 305 also connects to the controller 308. The controller 308 functions to control the operating parameters of the electrical component 305. The controller 308 can be implemented by using, inter alia, a Micro Processing Unit (MPU), Field Programmable Gate Array (FPGA), Application Specific Integrated Circuit (ASIC), etc. The controller 308 further connects to the module connector 310 for communicating with the controller of the Master module via the Bus 104. Other functions of the controller 308 will be become apparent as the operation of the PA 100 is discussed further.

In general, the functions of the controller 308 are as follows:
allow a power module 302 to operate as either a Master module or a Slave module;
allow a power module 302 to control other Slave modules when the power module 302 is operating as a Master module;
perform power calculations of the PA 100 (e.g., calculate total power available) when the power module 302 is operating as a Master module;
perform power calculations of the individual power module 302 (e.g., calculate power used or power generated over a period of time);
set output voltages of the power module 302;
set timers for enabling the supply converter to charge a battery;
produce reports of the module's performance and historical data;
access network (e.g., local area network, Internet);
control the module's electrical components 305;
manage inputs and outputs when the power module 302 is operating as a Master module;
monitor and control the environment of the PA 100 (e.g., fan speed) when the module 302 is operating as a Master module; and
any other function required by the PA 100, including power module firmware or bitstream updates.

The electrical component 305 is also connected to the sensors 309. The sensors 309 are configured to monitor the operational parameters of the electrical component 305, such as temperature, voltage, current, frequency, power factor, etc. The sensors 309 are connected to the controller 308 so that the sensors 309 can send the monitored parameters to the controller 308. The controller 308 then generates a report of the power module's operational parameters based on the monitored parameters. The report is continually updated and sent by the controller 308 to the controller of the Master module. The update of the report occurs at determined regular intervals (e.g., 10 milliseconds, 3 seconds, 5 minutes, 10 minutes, etc).

The module connector 310 is a complementary connector for connecting to the slot connector 106. When the module connector 310 is connected to the slot connector 106, the power module 302 is docked on the backplane 101. The module connector 310 is also capable of selectively connecting the output of the power module 302 to either the serial bus or the parallel bus of the Bus 104. Selection of connecting to the serial bus or the parallel bus is conducted with a switch (not shown). In one example, the switch is a solid state switch that is controllable by the controller 308.

Optionally, the power module 302 may be equipped with an input 304, an input switch 331, an output 316, an output switch 333 and one or more SCP 313 depending on the functionality of the power module 302.

For a power module 302 capable of receiving electrical power from an electrical power supply 10, the power module 302 is equipped with an input 304. The input 304 is configured for coupling to the electrical power source 10. For example, the input 304 may have a lead and a plug (e.g., a AS/NZS 3112 plug, a BS 546 plug, a CEE 7/4 plug, etc) that are typically used for coupling to a traditional General Purpose Outlet (GPO), which represents a mains electrical power supply 10. Other connection configuration may be used to allow connection to an electrical power source, such as hardwiring to an electrical power source 10.

The input 304 is then connected to the SCP 313, the input switch 331 and, in turn, to the electrical component 305. In this implementation, the electrical component 305 receives electrical power directly from the input 304 instead of from the Bus 104.

The purpose of the SCP 313 is to condition received electrical power supply 10 and to protect the electrical component 305 from any electrical surge. Examples of the SCP 313 are, inter alia, Residual-Current Device (RCD), filters, etc. In FIG. 1C, the SCP 313 is placed between the input 304 and the input switch 331. In an alternative embodiment, the SCP 313 may be placed between the input switch 331 and the electrical component 305.

The input switch 331 includes two switches: a mechanical switch and an electronic switch. The mechanical switch is a physical switch that a user of the PA 100 turns on after installation of the PA 100. One example of the physical switch is a Residual-Current Device (RCD). The electronic switch is controllable by the PA 100, via the controller 308. An example of the electronic switch is a solid state relay switch. Connection between the controller 308 and the input switch 331 is not shown so as to reduce clutter in FIG. 1C.

The input 304 and the input switch 331 are also connected to the sensors 309. The sensors 309 monitor the input 304 and the input switch 331. The sensors 309 then send the monitored parameters to the controller 308, so that parameters of the input 304 and the input switch 331 can be included in the report of the power module's operational parameters.

Similar to the input components (i.e., 304 and 331), an output 316, an SCP 313 and an output switch 333 can be equipped on the power module 302 to provide electrical power to a load 20. The output 316 is connected to the SCP 313, the output switch 333 and, in turn, to the electrical component 305. In this implementation, the electrical component 305 provides electrical power directly to the load 20, via the output 316, instead of to the Bus 104.

The output 316 is a power socket of the same configuration of the mains electrical power supply 10. An electrical load 20 can therefore connect to the output 316 with a standard mains electrical supply complementary plug.

A signal conditioning and protection (SCP) 313 is placed between the output 316 and the electrical component 305. The purpose of the SCP 313 is to condition electrical power going to the load 20 and to protect the load 20 from irregularity of electrical power output by the power module 302. Examples of the SCP 313 are, inter alfa, Residual-Current Device (RCD), filters, etc. In FIG. 1C, the SCP 313 is placed between the output 316 and the output switch 333. In an alternative embodiment, the SCP 313 may be placed between the output switch 333 and the electrical component 305.

The output switch 333 includes two switches: a mechanical switch and an electronic switch. The mechanical switch is a physical switch that a user of the PA 100 turns on after installation of the PA 100. One example of the physical switch is a Residual Current Device (RCD). The electronic switch is controllable by the PA 100, via the controller 308. An example of the electronic switch is a solid state relay switch. Connection between the controller 308 and the output switch 333 is not shown so as to reduce clutter in FIG. 1C.

The output 316 and the output switch 333 are connected to and monitored by the sensors 309, which in turn send the monitored parameters to the controller 308. The parameters of the output 316 and the output switch 333 are then included in the report of the power module's operational parameters.

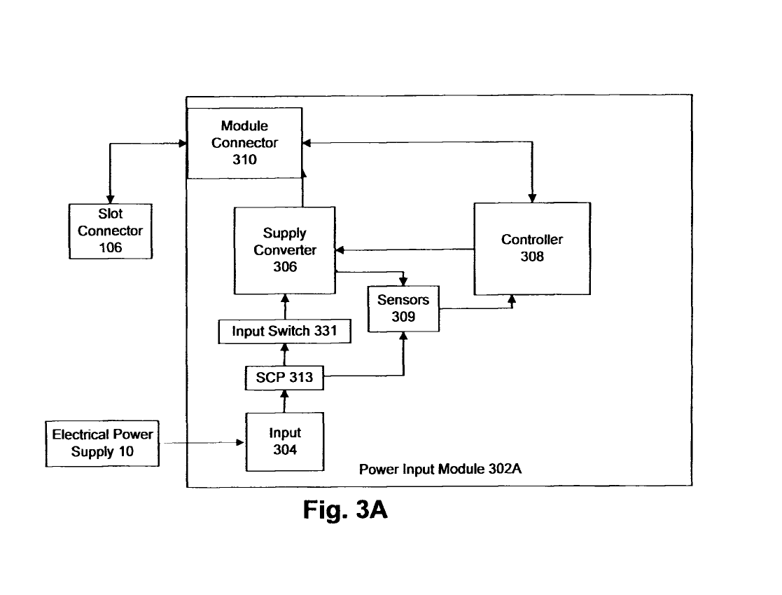

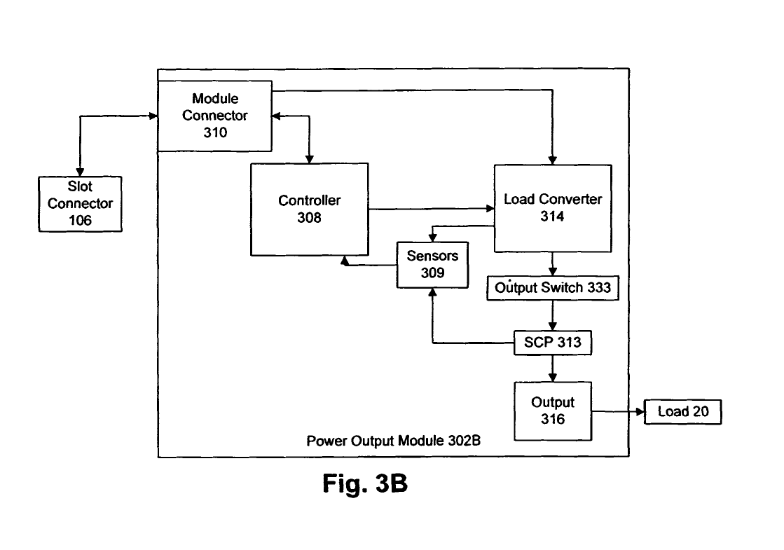

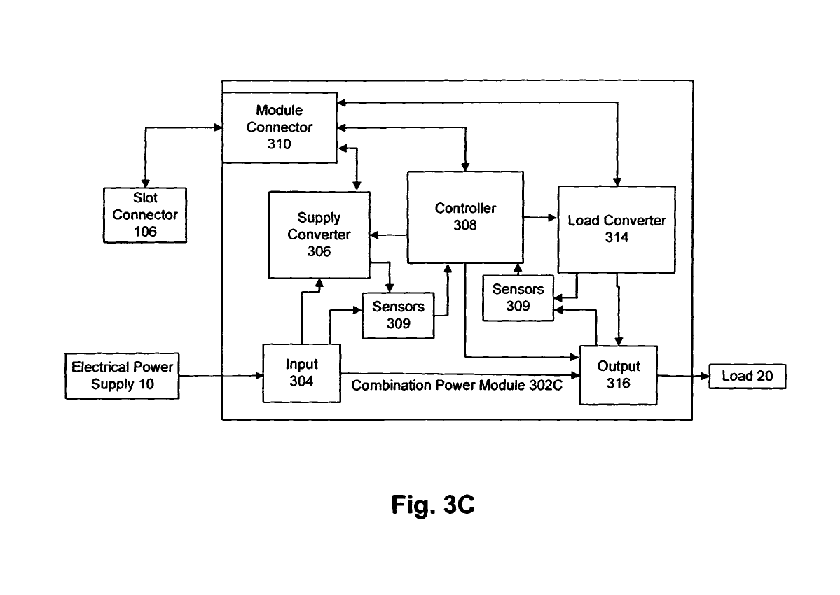

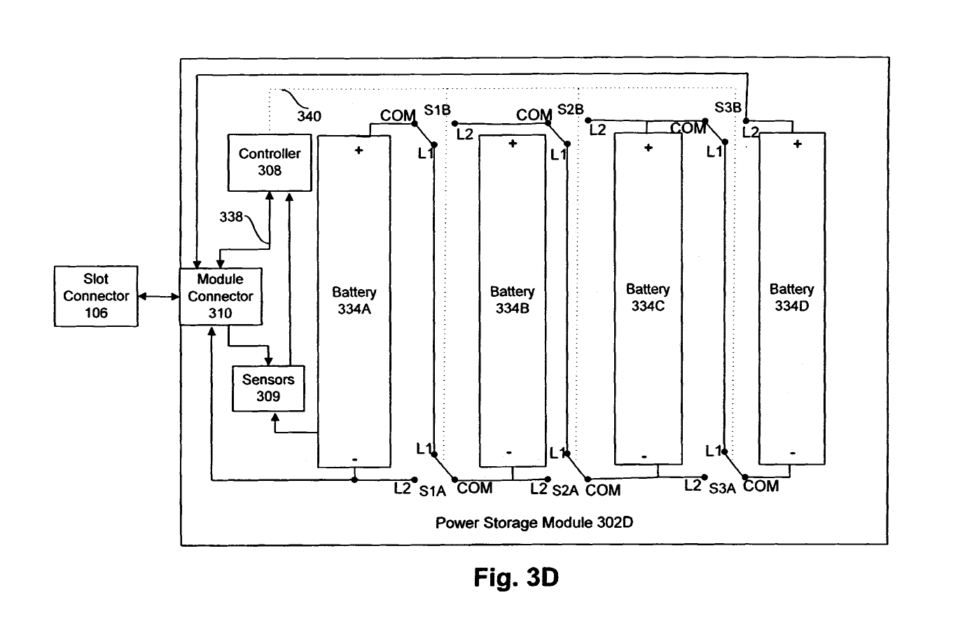

Example implementations of power module 302 will be discussed further in relation to FIGS. 3A to 3D.

As discussed above, the PA 100 operates on a master-slave system. Thus, there must be master-capable and slave-capable power modules 302. In this implementation, as a design choice, master-capable power modules 302 are power modules 302 that do not include power storage capabilities (e.g., batteries). Thus, power modules 302 including batteries are master-incapable.

Master-incapable power module is identified through a slave identifier object. In order to prevent a master-incapable power module 302 from being docked on slot 102N (i.e., master-only slot), the slot 102N has a blocking device preventing docking of master-incapable power modules 302.

In one implementation, the slave identifier object is a pin on a master-incapable power module 302. The blocking device of slot 102N then prevents the pin and therefore the master-incapable power module 302 from docking on the slot 102N. On the other hand, notches are provided on slots 102A to 102M so as to allow the pin to enter into the notches and effectively dock the master-incapable power module 302 on the slots 102A to 102M.

FIG. 1D shows a side elevation view of the PA 100. The example illustrates how the power modules 302, the backplane 101, the electrical power supplies 10 and the electrical loads 20 are connected physically.

The power modules 302 are docked on the backplane 101 by engagement of the module connectors 310 to slot connectors 106. As can be seen from FIG. 1D, unused slot connector 1061 is left empty. To prevent electrocution to a user of the PA 100, the unused slot connector 1061 is covered by an insulating material.

As can be seen from FIG. 1D, a power module 302 receives electrical power from the electrical power supply 10 via input 304, and outputs electrical power to the electrical loads 20 via output 316. In the example of FIG. 1D, power modules 302F, 302G and 302H are able to receive electrical power from a mains electrical power supply 10A, solar panels 10C and generators 10D, respectively. These power modules 302F, 302G and 302H receive electrical power via inputs 304F, 304G and 304H, respectively.

Power modules 302E and 302D are able to output electrical power, via outputs 316E and 316D, to electrical loads 20B and 20A, respectively. Each of these power modules 302D to 302H has electrical components 305 which are not shown in this example.

Power modules 302A to 302C in the example of FIG. 1D comprise batteries as the electrical components 305 and are placed at the bottom of the PA 100 because of the batteries' weight. Further, in a preferred implementation, the power modules 302A to 302C do not have any inputs 304 or outputs 316.

FIG. 1E shows an exemplary backplane 101 implemented in accordance with the arrangement described in FIG. 1. Each of the slot connectors 106A and 106B is preferably able to accommodate 45 amperes of current in each individual connector thereof. The slot connector 106 is hardwired to the Bus 104 for directly connecting a docked module to the Bus 104.

The Bus 104 is desirably covered with dielectric insulation for protection of the high voltage, high current electrical lines. Voids 120A and 120B are formed in the PCB of the backplane 101 to assist with air circulation for thermal management of a docked module 302. Fans (not shown) may also be used to further assist with thermal management of docked modules.

Holes 130 are formed in the PCB of the backplane 101 to assist with affixing the backplane 101 to the housing 90 using screws (not shown).

The blocking device 103 for a master-only slot 102N is implemented here as part of the PCB 101 on the side of the slot connector 106A. On the other hand, the notch 105 is shown as an absence of the PCB 101 on the side of the slot connector 106B.

FIG. 2 is a flowchart showing a method 200 for configuring the PA 100. Before discussing steps of the method 200, the assembly of the PA 100 is discussed first.

Before a PA 100 is assembled, a user determines the functionalities required by the PA 100. Based on the determined functionalities, the user selects the required power modules 302 and manually docks the selected power modules 302 on the PA 100. Once all power modules 302 are docked on the PA 100, the electrical power supplies 10 and/or the loads 20 are connected to the PA 100. The user then turns on the mechanical switches of the input switches 331 and the output switches 333. The PA 100 is now ready to be configured for the required functionalities.

Method 200 commences at step 202. Step 202 commences through a user-initiated command via a user interface. Examples of the user interface are, inter alia, a start button, a video display with touch-control, etc. When the PA 100 receives the user-initiated command, the 3.3V digital supply of the Bus 104 is powered up to provide power to docked power modules 302 of the PA 100 on the slots 102B to 102N (i.e., slots capable of accommodating a Master module). Each power module 302 docked at slots 102B to 102N then declares the capability to act as a Master module. Step 202 continues to step 204

At step 204, a Master module is determined from the docked power modules 302. The operation of the PA 100 is governed by a Master module, which is selected from the power modules 302 docked on the backplanes 101. As discussed above, slot 102N is designated as master-only and, thus, a power module 302 docked on any of the slot 102N must be master-capable.

If a plurality of backplanes 101 is installed on the PA 100, the Master module is determined based on a descending order of position of the backplane 101 (i.e., backplane 101M is on the highest order and backplane 101A is on the lower order). Thus, a power module 302 on slot 102n of backplane 101M is selected as a Master module. If power module 302 is not available on slot 102N of backplane 101M, then a power module 302 on slot 102N of backplane 1011 is selected as a Master module. This process continues down the order of the backplane 101 until a Master module is selected.

As discussed above, a power module 302 docked on slots 102B to 102M can be assigned as a Master module for redundancy purposes. Therefore, in the event that no power module 302 is available on slot 102N of any of the backplanes 101, then a power module 302 on the remaining slots 102 (e.g., 102B to 102M) can be designated as a Master. Similar to the process above, the selection of a Master module starts from slot 102M down to 102B of backplane 101M. The selection process then continues down the order from backplane 101M to backplane 101A.

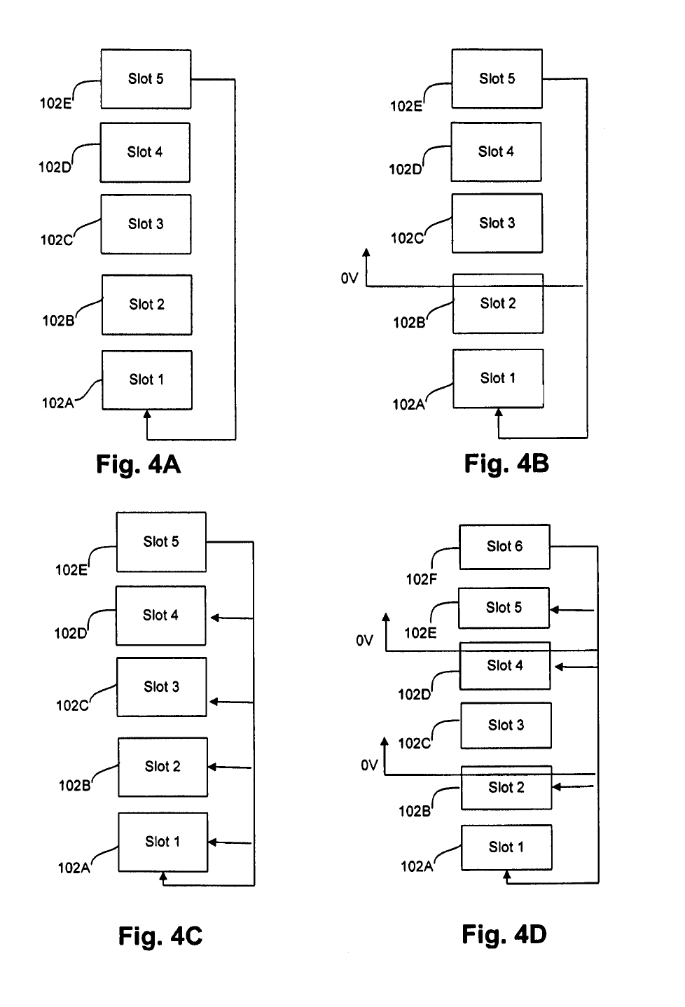

The Master module provides control and coordination of the backplanes 101 by providing control signals to the controller 308 of each docked power module 302. Examples of other functions of a Master module are to rearrange the grouping of the power modules 302 and to control the operation of each of the power modules 302. The grouping of the power modules 302 will be described in detail in relation to FIGS. 4A to 4D.

Although each power module 302 is capable of operating independently, power modules 302 set as Slaves modules defer to a Master module for correct system operation and coordination. For example, the Master module sets all fans to a particular speed based on the average temperature of all docked power modules. This prevents one working power module 302 from driving the fan at maximum speed whilst other idle power modules 302 turn their fans off, thereby giving a quiet mode of operation and cooling.

Once a Master module is selected from the docked power modules 302, step 204 proceeds to step 206.

At step 206, the Master module systematically sends control signals to each of the docked power modules 302. In response to the received control signals, the controller 308 of each docked power module 302 sends the characteristics of the power module 302 to the Master module allowing the Master module to determine the available electrical components 305 in the PA 100. Some examples of the characteristics are, inter alia, the module's voltage, capacity, attributes, features and history from the memory of the power module 302 (e.g., ID ROM). The controller 308 of the Master module then implements a register map that comprises the characteristics of each docked power module 302. Once the Master module has implemented the register map, step 206 proceeds to step 208.

At step 208, the Master module determines whether the characteristics of the docked power modules 302 are able to meet a determined configuration of the PA 100. Upon determining that the docked power modules 302 are capable of providing the required configuration of the PA 100 (YES), step 208 proceeds to step 210. Otherwise (NO), the method 200 proceeds to step 209.

At step 209, an error message is raised and the docked modules 302 are not powered up. Examples of the error message are, inter alia, blinking red LED, a pre-determined beeping or alarm, a fault indicator in a visual process flow web graphic, etc. The method 200 concludes.

At step 210, the Master module powers up the digital 5.0V supply to power up all functionalities of the docked power modules 302. Upon powering-up the docked power modules 302, the Master module can set the configuration of the PA 100 by setting the operating parameters of each docked power module 302. The method 200 concludes.

The power module 302 of FIG. 1C can be classified into: a Power Input Module (PIM), a Power Storage Module (PSM), and a Power Output Module (POM). The functions of the PIM are to protect the components of the PA 100, and perform any one of the following functions: power factor correction, rectification, boosting, bucking and regulation of received electrical power supplies. In some implementations, the PIM functions to charge the PSM. Some electrical components 305 that can be included in the PIM to fulfil the above-mentioned functions are, inter alia, a power factor corrector, a rectifier, a charger, a boost converter, a buck converter, a voltage regulator, and an active rectifier.

FIG. 3A shows an example of a PIM 302A including an input 304, a SCP 313, an input switch 331, a supply converter 306, a controller 308, sensors 309, and a module connector 310. By adjusting the number of PIMs 302A used, the PA 100 can be readily scaled. For example, using one PIM 302A having a 12V AC input allows the PA 100 to receive a 12V AC input. Then, by adding another PIM 302A having a 400V AC input allows the PA 100 to receive 400V AC input.

The supply converter 306 is connected, via the SCP 313 and the input switch 331, to the input 304 to receive electrical power from the electrical power supply 10. In one implementation, the supply converter 306 is a rectifier and a charger unit configured to rectify an AC mains supply, received at the input 304, to DC for charging a PSM coupled via the slot connector 106. The PSM will be described in detail in relation to FIG. 3D. The SCP 313 and the input switch 331 are as described above in relation to FIG. 1C.

The supply converter 306 is connected to the module connector 310, which in turn is connected to the slot connector 106 and in turn connected to the Bus 104, for charging the PSM via the Bus 104.

Other implementation examples of the supply converter 306 are a Single-ended primary-inductor converter (SEPIC) converter for converting a DC voltage from the local solar panels to a usable DC voltage for supply to a POM, a buck converter for converting a DC voltage of the local solar panels to a lower DC voltage for supply to a POM, or boosting to supply to a PSM, a power factor corrector for correcting the power factor of a DC voltage of the local wind turbines for charging the PSM, etc.

The supply converter 306 allows the DC output of the solar panels 10B, or the AC output of the wind turbines 10C, to be drawn dynamically, consistently, and linearly.

The supply converter 306 is connected to the sensors 309 and the controller 308. The operations of the input 304, the controller 308 and the sensors 309 are as discussed above.

A POM functions to provide electrical power to a local electrical load 20, or into a power distribution grid via a grid tie protocol or other industry compliant protocol. The POM may draw electrical power from either the PSM or the PIM. In one example where the POM draws power from the PSM, the POM converts a DC voltage of the PSM to an AC voltage for supply to the load. In another example, the POM may use a buck converter to step down the DC voltage of the PSM for supply to an electrical load 20. Examples of outputs that can be provided by the POM are, inter alia, AC outputs (e.g., 240V, 230V, 110V, etc) or DC outputs (e.g., 48V, 400V, etc). Similar to the NM, the PA 100 is readily scalable by having different number of like-configured POMs. Outputs of the PA 100 may range, for example, from 2.4 kVA to 160 kVA.

FIG. 3B shows an example of a POM 302B including a controller 308, sensors 309, a load converter 314, and output switch 333, a SCP 313, an output 316, and a module connector 310. The functionalities of the module connector 310, the controller 308, the sensors 309, the output switch 333, the SCP 313 and the output 316 are as described hereinbefore.

The load converter 314 is connected to the module connector 310, which in turn is connected to the slot connector 106 and in turn to the bus 104, for receiving electrical power from either the PSM or the PIM. The load converter 314 is also connected to the output 316, via the output switch 333 and the SCP 313, to supply electrical power to a load 20. In one implementation, the load converter 314 is an inverter configured to convert a DC voltage of the PSM or the PIM to an AC voltage for supply to the electrical load 20. In another implementation, the load converter 314 is a boost converter for boosting a DC voltage of the PSM to a higher DC voltage for supply to the load 20. In yet another implementation, the load converter 314 is a buck converter for bucking a DC voltage of the PIM to a lower DC voltage for supply to the load 20.

FIG. 3C shows an example of a combination power module (CPM) 302C. In this example, the CPM 302C is a combination of the PIM 302A and the POM 302B. The CPM 302C includes an input 304, an input switch 331, a supply converter 306, a load converter 314, an output 316, an output switch 333, SCPs 313, a controller 308, sensors 309, and a module connector 310.

The input switch 331, the output switch 333 and the SCPs 313 are not shown in FIG. 3C to simplify the drawings. The operations of these components are as described above.

The operation of each of the components is the same as described in relation to FIGS. 1C, 3A and 3B. One difference in this example of the CPM 302C is the capability of switching the electrical power provided by the output 316. The output 316 is connected to both the input 304 and the load converter 314. The output 316 includes a switch (not shown), which is controlled by the controller 308, for selecting the electrical power (i.e., electrical power from either the input 304 or the load converter 314) to be supplied to a connected electrical load 20.

In another example of the CPM 302C, the supply converter 306 is a rectifier to rectify an AC voltage from a mains electrical power supply to a DC voltage. The supply converter 306 then supplies the DC voltage to the load converter 314, which in this example is a buck converter. The buck converter 314 down-converts the DC voltage for supply to the load 20.

There are other combinations of PIM and POM to create a CPM. Conversely, each electrical component 305 of the PIM or the POM may be put into a separate module 302. For example, a supply converter 306 is in one module 302 and an input 304 is in another module 302.

The PSM functions to store energy and provides the stored energy to the POM when required. In a preferred implementation, the PSM is a battery bank. Examples of the batteries used in the PSM are, inter alia, lead-acid batteries (and derivatives), lithium-ion batteries (and derivatives), electrolytic devices, etc. FIG. 3D shows an example of the PSM 302D having a module connector 310, four batteries 334A to 334D, six switches (i.e., S1A, S1B, S2A, S2B, S3A, S3B), sensors 309 and a controller 308.

As described hereinbefore, the module connector 310 provides the PSM 302D with the connection to a slot connector 106 for docking to a slot 102 and selectively connects the PSM 302D to either the parallel or the serial bus of the Bus 104. Such connections allow a plurality of PSMs 302D to be placed in either a serial or a parallel configuration.

The functionalities of the sensors 309 and the controller 308 are as described hereinbefore. In this particular implementation, the sensors 309 monitor the operational parameters of the batteries 334 (e.g., temperature, voltage, current, hydrogen gas released, etc). The sensors 309 are not shown to be connected to all of the batteries, collectively referred to as 334, to reduce cluttering of FIG. 3D.

The batteries 334 are connected via six switches (i.e., S1A, S1B, S2A, S2B, S3A, S3B), collectively referred to as S. In this example, the switches S are Single-Pole-Double-Throw (SPDT) switches, but other switch types (e.g., two Single-Pole-Single-Throw switches to replace one SPDT switch) are possible. Some examples of the switches S are, inter alia, manually operable switches, controllable relays, insulated gate bipolar transistor (IGBT), MOSFET's, optically controlled solid state. The switches S allow the batteries 334 of a PSM 302D to be connected in either of a serial configuration or a parallel configuration. For four 12 Volt batteries, output voltages of 12, 24 and 48V DC can be obtained by appropriate switch connections.

The negative terminal of battery 334A is connected to the slot connector 106, via module connector 310, to provide the Negative Battery Voltage Terminal or the Digital Ground of the Bus 104. The positive terminal of battery 334D is connected to the switch in module connector 310 to provide electrical power of PSM 302D to either the serial or the parallel bus of the Bus 104.

To set the batteries 334 of the PSM 302D in a serial configuration, the positive terminal of a battery 334 is connected to the negative terminal of a subsequent battery 334. The negative terminal of the first battery 334 and the positive terminal of the last battery 334 represent the total voltage of the serial configuration of the batteries 334.

To set the batteries 334 of the PSM 302D in a parallel configuration, the positive terminals and the negative terminals of batteries 334 are connected to the positive terminals and the negative terminals of the other batteries 334, respectively.

In order to switch between serial and parallel battery configurations, the poles, referred to as COM, of the switches S are connected to the terminals of the batteries 334. The first throws L1 of the switches S are connected together. The second throws L2 of the switches S are connected to either i) the negative terminal if the pole COM of the switch S is connected to a negative terminal of a subsequent battery 334; or ii) the positive terminal if the pole COM of the switch S is connected to a positive terminal of a subsequent battery 334.

Thus, to set the batteries 334 to a serial configuration, the switches S are connected to the first throws L1 thereby connecting the positive terminals of the batteries 334 are connected to the negative terminals of the subsequent batteries 334. In this example, the positive terminal of the battery 334A is connected to the negative terminal of the battery 334B.

In order to set the batteries 334 to a parallel configuration, the switches S are connected to the second throws L2 thereby connecting the positive terminals to other positive terminals of the batteries 334. Similarly, the negative terminals are connected to other negative terminals of the batteries 334. Although only four batteries are shown in this example, the number of batteries in the PSM 302D may be adjusted to suit the need of the PA 100.

The controller 308 is connected via connection 340 to the switches S, which are all ganged to each other. The controller 308 switches the battery configuration (i.e., serial or parallel) by sending a control signal to the switches S. For example, the controller 308 sends a control signal (e.g., 5V pulse) to switch the switches S to connect to either the first throw L1 or the second throw L2. Alternatively, the battery configuration of the PSM 302D may be determined from instructions stored in the PSM's Read-Only Memory (ROM).

The type of battery configuration (i.e., parallel or serial) selected depends on the desired power output and capacity. The option of either serial or parallel connections allows the PA 100 to produce multiple output voltages and currents that are matched in output impedance, between power domains. Impedance matching is also controlled in the communications domain to provide high speed communications for large modular power arrays.

Impedance in the power domain is regulated through low equivalent series resistance (ESR) capacitors in the POM and PIM, whilst impedance in the communications domain is defined and fixed according to the routing on the backplane 101, the connections between the master module and the slave modules. Management of the impedance is done through capacitors in POMs and PIMs, which is controlled and determined by comparing the performance data from the PSM to either the PIM or the POM. The matching of the output impedance results in higher efficiency.

As mentioned hereinbefore, a plurality of the PSMs 302D can be grouped in either a serial or a parallel configuration. The grouping of the PSMs is determined by the output requirements of the POM. The POM requests a particular voltage/current from the PSMs, which respond by configuring the PSMs grouping for this capability. If the grouping is not available, the POM requests for the next best (usually for efficiency) configuration and the master module determines if all PSMs can comply with that grouping.

FIGS. 4A to 4D show examples of serial and parallel connections of the PSMs 302D. FIG. 4A shows an example of one serial group (slot 1 to slot 5) of five PSMs 302D docked to slots 102A to 102E. For example, each PSM 302D docked to the slots 102A-102E has 48V DC. The output of the serial grouping of the PSM 302 configuration of FIG. 4A is 240V DC, thus being well-suited to supply a 400 VDC load 20 through a boosting process, or a 110V AC load through an inversion process.

FIG. 4B shows an example of two serial groups (i.e., slots 1 and 2, and slots 3 to 5) of PSMs 302D. If each PSM 302D has 48V DC, the first group has an output of 96V DC whilst the second group has an output of 144V DC. Multiple serial groups may be created by the PA 100. Some of the advantages of using multiple serial groupings of battery modules are: redundancy and prioritizing of electrical load.

A redundancy example is if one of two serial groups that provides power to an electrical load malfunctions. The functioning serial group may take over the provision of electrical power completely, thereby preventing the loss of electrical power to the electrical load 20.

An example of prioritizing is when there are two serial groups of battery modules and two electrical loads. In a normal operation, each serial group provides power to one of the two electrical loads. However, if one serial group malfunctions, the Master module of the PA 100 determines which of the two electrical loads is more important and provides electrical power to the more important electrical load 20, whilst letting the other electrical load 20 to lose electrical power.

FIG. 4C shows an example of five PSMs 302D in parallel configurations. The parallel connection has increased capacity and increased battery duration over the serial connection.

FIG. 4D depicts PSMs 302D in a parallel connection (slots 102E and 102F) and two serial groups (i.e., slots 1 and 2, and slots 3 and 4). The output of the parallel groups can be shared with several serial groups to give increased power capacity to the serial groups. For example, each output of the PSM 302D located at slots 5 (102E) and 6 (102F) is 96V DC. Each output of the slots 102A to 102C is 48V DC. The output of slot 102E can be shared with the output of slots 102A and 102B to increase the power capacity of the serial group.

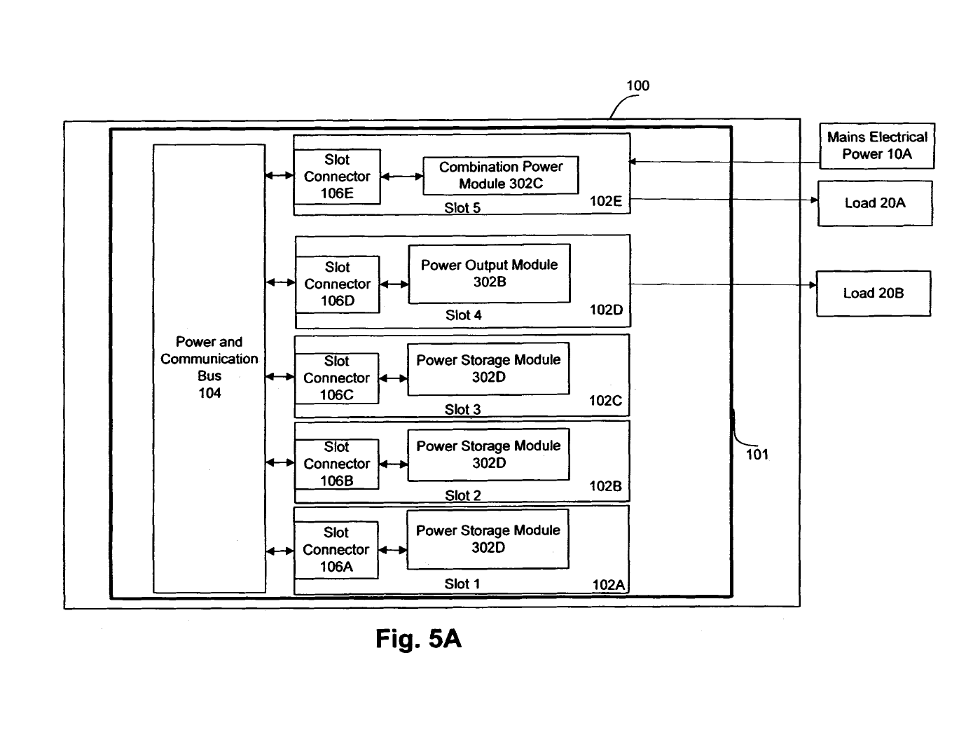

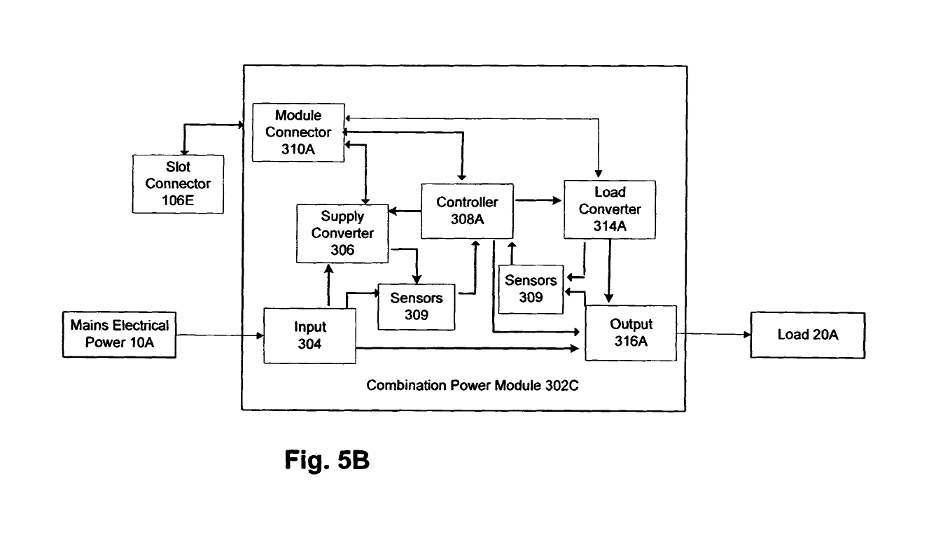

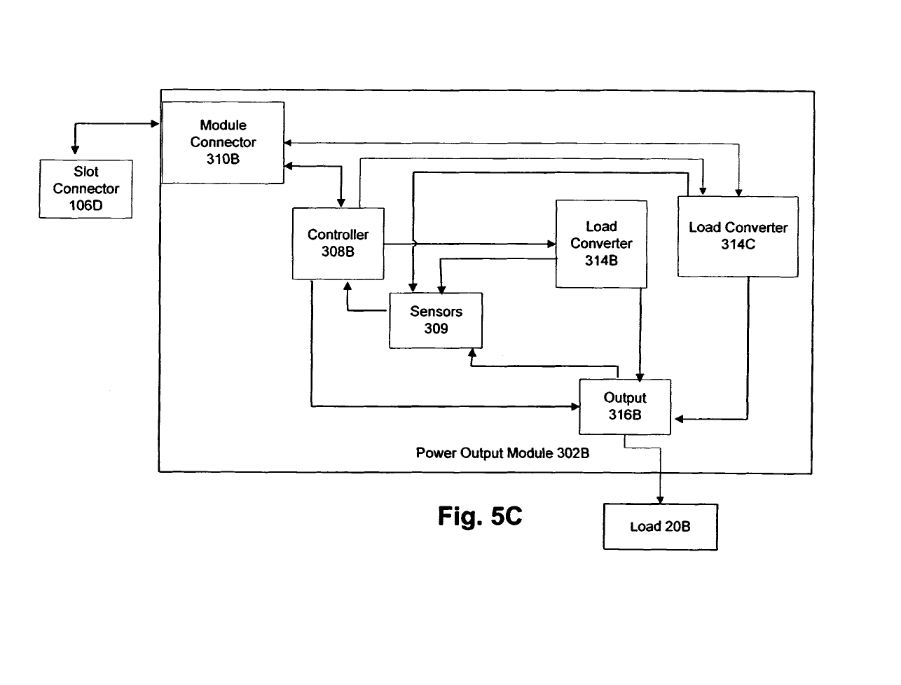

FIGS. 5A to 5C show an example of a PA 100 functioning as a backup supply for two different electrical loads 20A and 20B. The PA 100 of this example receives electrical power from a mains electrical power supply 10A. The two electrical loads 20A and 20B are devices requiring 240V AC voltage and 110V AC voltage, respectively. Thus, the functions of this PA 100 are to store electrical power to batteries and discharge the batteries to provide electrical power when the mains electrical power 10A malfunctions.

To fulfil these functions, the PA 100 requires: 1) PSMs 302D each having a number of batteries for storing electrical power; 2) a PIM 302A for converting the AC voltage of the mains electrical power to a DC voltage for charging the PSM 302D; and 3) two POMs 302B for converting the PSM's DC voltage to: a) 240V AC and b) 110V AC.

In this example, one PIM 302A and one POM 302B have been combined as CPM 302C to reduce the number of power modules 302 used. FIG. 5B shows an exemplary CPM 302C for this example. The CPM 302C is located at the top slot 102E as shown in FIG. 5A, and is set as the Master module during the power-up procedure, in accordance with the method 200. The CPM 302C includes an input 304 for receiving the mains electrical power supply 10A, a supply converter 306 (i.e., a rectifier and a charger) for charging the PSMs 302D, a load converter 314A (i.e., an inverter) for converting the DC voltage of the PSM 302D to 240V AC voltage, and an output 316A for supplying the 240V AC electrical power from either the input 304 or the load converter 314A.

The CPM 302C also includes a controller 308A, sensors 309, and a module connector 310A, the functions of which are as described hereinbefore. The CPM 302C also includes SCPs 313, an input switch 331 and an output switch 333 which are not shown in the example. The SCPs 313, the input switch 331 and the output switch 333 are as described above.

The input 304 is connected to the module connector 310A to provide the mains electrical power supply to the Bus 104. During normal operation, the output 316A is connected to the input. When the mains electrical power supply 10A malfunctions, the controller 308A sends a control signal to the output 316A to switch to the inverter 314A.

FIG. 5C shows an exemplary POM 302B, which is located at slot 102D. The POM 302B includes two load converters 314B (i.e., an inverter) and 314C (i.e., a transformer or a step-down transformer). The inverter 314B is for inverting the DC voltage of the PSM 302D to 110V AC voltage, whilst the transformer 314C is for isolating the power sources for compliance in grid tie applications. If the converter 314C is a step-down transformer, the converter 314C is used for down-converting the 240V AC of the mains electrical power supply to 110V AC.

An output 316B is connected to both of the load converters 314B and 314C via a switch (not shown), which is controllable by the controller 308B for selecting the load converters 314B, 314C to be connected to the output 316B. In normal operation (i.e., functioning mains electrical supply 10A), the step-down transformer 314C is connected to the output 316B. If the mains electrical power supply 10A malfunctions, the controller 308B receives a control signal from the controller 308A to send a control signal to the switch of the output 316B to connect to the inverter 314B.

The POM 302B is set as a Slave module in accordance with the method 200. However, the POM 302B may take over as a Master module if required. The functions of the sensors 309 and the controller 308B are as described above.

Three PSMs 302D are located at slots 10A to 102C, as shown in FIG. 5A. The PSM 302D located at the slot 102A is set as a Slave module, in accordance with the method 200. The two PSMs 302D, located at the slots 102B and 102C, are also set as Slave modules, but these two PSMs 302D cannot become a Master module in accordance with the design choice discussed above.

In one implementation, each of the PSMs 302D in this example provides 48V DC output voltage, and has been configured in a serial configuration. Further, all the power modules 302 are configured as one group. In another implementation, one of the PSM 302D is configured as a parallel configuration to provide additional power capacity to the other PSMs 302D.

In this example, if the POM 302B is no longer needed because the 110V AC device is replaced to 110V DC device, then the POM 302B is either replaced with another POM 302B or reconfigured electronically for the new desired output. The replacement or reconfigured POM 302B includes a boost converter as the load converter 314B for boosting the DC voltage of the PSM 302D to 110 VDC, and a rectifier and a buck converter as the load converter 314C for converting the AC voltage of the mains electrical supply to 110V DC.

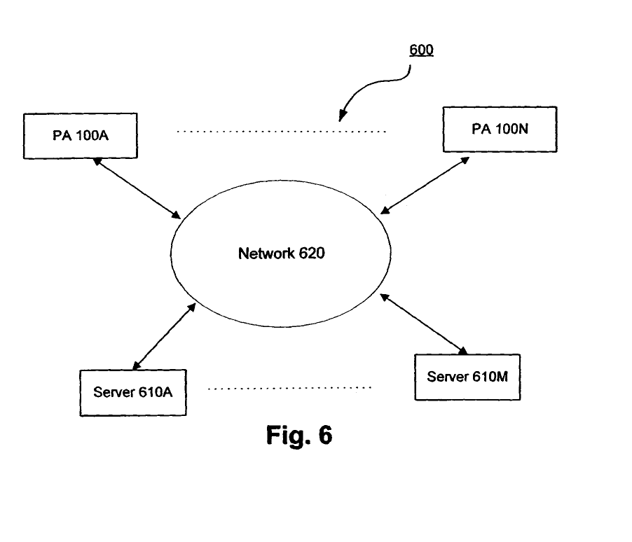

FIG. 6 shows a system 600 including one or more PA 100, one or more servers 610 and a network 620. The system 600 allows for the PA 100 to be remotely controlled by the one or more servers 610 via the network 620. The servers 610 manage′ the operations of the PA 100 by communicating with the Master module of the PA 100. The network 620 may be a local area network (LAN) or Wide Area Network (WAN).

The servers 610 maintain a copy of the register map of each of the PA 100 under the control of the servers 610. In the event that a PA 100 fails, the failed PA 100 can be replaced with another PA 100. The servers 610 can then configured the new PA 100 based on the register map. If the new PA 100 is capable of being configured to the required functionalities, the method 200 is performed on the new PA 100 and the system 600 is restored to the original functionalities.

Otherwise, an error is sent to the users advising that the new PA 100 is incapable of meeting the required functionalities.

The reconfigurable power apparatus as described hereinbefore provides benefits such as flexibility, scalability and modularity. These benefits translate to commercial benefits such as cheaper labour costs (through shorter assembly time and simplicity of assembly), cheaper assembly costs (through cheaper labour costs), higher production rate (through standardisation of components), lower development costs (through having one core design), scalability of assembly and cheaper production costs.

Some of the electrical components of the reconfigurable power apparatus are expensive (e.g., batteries). Therefore, the reconfigurable power apparatus's capability to swap batteries to closely match the batteries' properties with the load's requirements means that the reconfigurable power apparatus becomes more cost effective.

### INDUSTRIAL APPLICABILITY

The arrangements described are applicable to the electrical industries requiring an electrical power apparatus.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A power supply apparatus for supplying electrical power to at least one electrical load, the power supply apparatus comprising:
at least one backplane comprising:
a plurality of slots each adapted to engage with a corresponding removably engageable power module; and
a bus coupled between each of the slots; and
a plurality of said power modules, each power module being removably engageable with one of the plurality of slots, the power modules communicating and distributing power with one another via the bus, wherein the plurality of said power modules are configured for supplying electrical power to the at least one electrical load, wherein the plurality of power modules comprise:
at least one input component for receiving electrical power from an electrical power supply and providing the received electrical power to the bus;
at least one battery component for storing electrical power derived from the bus and providing electrical power to the bus;
at least one charging component for receiving electrical power from the bus and providing charging power to the bus for charging the at least one battery component; and
at least one output component for receiving, via the bus, electrical power from the at least one battery component and supplying electrical power to the at least one electrical load.

2. The power supply apparatus of claim 1, wherein each of the power modules further comprises:
a controller configured to:
receive a first control signal, via the bus, from a corresponding controller of another power module; and
send a second control signal, based on the first control signal, to a corresponding controller of one other power module via the bus.

3. The power supply apparatus of claim 2, wherein one of the power modules is assigned as a master module and the remaining power modules are assigned as slave modules.

4. The power supply apparatus of claim 3, wherein each of the power modules further comprises:
at least one sensor, coupled to the controller of the power module and to at least one component of the power module, the at least one sensor being configured to monitor electrical parameters of the at least one component of the power module.

5. The power supply apparatus of claim 4, wherein the controller of the power module is configured to:
receive the monitored electrical parameters;
produce a report based on the monitored electrical parameters; and
send the report to the controller of the master module, wherein the controller of the master module uses the report to monitor the performance of the power supply apparatus.

6. The power supply apparatus of claim 1, wherein the backplane further comprises:
a board connector, coupled to the bus, for connecting one said backplane to at least one other said backplane.

7. The power supply apparatus of claim 6, further comprising:
a modular direct connection for connecting the board connector to another board connector of the at least one other said backplane.

8. The power supply apparatus of claim 1, wherein the bus comprises electrical connections at least for communications selected from the group of electrical connections consisting of:
serial peripheral interface;
system management bus;
RS485;
USB2; and
any combinations of the above electrical connections.

9. The power supply apparatus of claim 1, wherein the at least one output component comprises:
a boost converter for boosting the electrical power, the boosted electrical power being supplied to the at least one electrical load;
a buck converter for bucking the electrical power, the bucked electrical power being supplied to the at least one electrical load;
an inverter for inverting the electrical power, the inverted electrical power being supplied to the at least one electrical load; or
a transformer for receiving the electrical power from the inverter and converting the inverted electrical power, the converted electrical power being supplied to the at least one electrical load.

10. The power supply apparatus of claim 1, wherein the at least one input component comprises a regulator for receiving and regulating the received electrical power, the regulated electrical power being supplied to the at least one electrical load.

11. The power supply apparatus of claim 1, wherein each of the slots comprises a slot connector for engaging with one of the plurality of power modules.

12. The power supply apparatus claim 11, wherein each of the power modules further comprises:
a module connector, coupled to the electrical components, adapted to engage with the slot connector, the module connector configured to:
receive electrical signals from the engaged slot connector; and
send electrical signals to the engaged slot connector.

13. The power supply apparatus of claim 1, wherein each of the power modules further comprises:
a master identifier pin for identifying whether the power module is capable to operate as a master module.

14. The power supply apparatus of claim 1, wherein the backplane further comprises one or more fans for thermal management of the power modules engaged with the slots.

15. The power supply apparatus of claim 1, wherein the backplane further comprises one or more voids for thermal management of the power modules engaged with the slots.

16. The power supply apparatus of claim 1, wherein the battery component comprises:
two or more batteries for storing electrical power.

17. The power supply apparatus of claim 16, wherein the battery component further comprises;
switches to selectively connect the two or more batteries in either of a serial connection or a parallel connection.

18. The power supply apparatus of claim 1, wherein the output component is configured to be a general purpose outlet for supplying electrical power at or above 48V DC or 110V AC to the at least one electrical load.

19. The power supply apparatus of claim 1 further comprising:
one or more servers connected to the one or more power supply apparatus, the one or more servers configured to manage operations of the one or more power supply apparatus.

20. The power supply apparatus of claim 19, wherein the one or more servers are connected to the power supply apparatus via either a local area network or a wide area network.

21. A method for configuring a reconfigurable power supply apparatus, the method comprising:
determining a master module from a plurality of power modules connected to the reconfigurable power supply apparatus;
providing a first electrical power to the plurality of power modules, the first electrical power being configured to power-up a communication system and an identification memory of each of the plurality of power modules, the identification memory comprises characteristics of the power module;
sending control signals, by the master module, to the plurality of power modules;
in response to the sent control signals, sending the characteristics of each of the plurality of power modules, using the communication system, to the master module;
receiving, at the master module, characteristics of each of the plurality of power modules;
determining whether the characteristics of the plurality of power modules are able to meet a determined configuration of the reconfigurable power supply apparatus;
if the characteristics of the plurality of power modules are able to meet the determined configuration of the reconfigurable power supply apparatus, providing a second electrical power to the plurality of power modules to power-up each of the plurality of power modules; and
sending control signals, by the master module, to the plurality of power modules to configure operating parameters of each of the plurality of power modules.

22. The method of claim 21, further comprising:
if the characteristics of the plurality of power modules are not able to meet the determined configuration of the reconfigurable power supply apparatus, sending an error message.
